(19) United States
(12) Patent Application Publication
(10) Pub. No.: US 2008/0046352 A1
(43) Pub. Date: Feb. 21, 2008

(54) System for Charging Royalty of Copyrights in Digital Multimedia Broadcasting and Method Thereof

(75) Inventors: Chang-Hyun Jung, Seongnam-si (KR); Chang-Ryul Lee, Seoul (KR)

Correspondence Address: BAKER & DANIELS LLP, 205 W. JEFFERSON BOULEVARD, SUITE 250, SOUTH BEND, IN, 46601, US

(73) Assignee: Mobilians Co., Ltd., Seoul (KR)

(21) Appl. No.: 11/570,053

(22) PCT Filed: Jun. 7, 2005
(86) PCT No.: PCT/KR05/01693

§ 371 Date: Dec. 5, 2006

(30) Foreign Application Priority Data
Jun. 9, 2004 (KR) 10-2004-0042236

(51) Int. Cl. G06Q 50/00; G06F 17/40; H04N 7/00; G06Q 40/00

(52) U.S. Cl. 705/37; 705/400

(57) ABSTRACT

A system for charging a copyright royalty in a digital multimedia broadcasting, and a method for the same are disclosed, which are designed to store the contents of the current broadcasting as a user performs a key operation or reservation for storing the contents at a receiving terminal. A charge data is generated for charging a copyright royalty of the contents stored by the user and is transmitted to a charge process service provider computer. The charge process service provider computer calculates a copyright royalty based on the received charge data. The copyright royalty calculation information is transmitted to the DMB service provider computer. The DMB service provider computer charges a copyright royalty based on the received copyright royalty calculation information.

### TECHNICAL FIELD

The present invention relates to a system for charging the royalty of copyrights in a digital multimedia broadcasting and a method for the same, and in particular to a system for charging the royalty of copyrights in a digital multimedia broadcasting and a method for the same, which are capable of recognizing an operation that users, which use a DMB (Digital Multimedia Broadcasting) through a receiving terminal, store a certain content such as a sound source, an image, etc. and charging the above operation.

### BACKGROUND ART

Recently, a DMB (Digital Multimedia Broadcasting) has been developed, which represents a broadcasting service in which various multimedia signals such as a high definition image, a CD quality music, etc. are provided to a fixed or portable or vehicle type receiver based on a digital method.

The digital multimedia broadcasting provides a broadcasting service with a high quality sound or high definition image like CD or DVD through a personal cellular phone (cellular phone, PCS phone, etc), a personal portable information terminal (PDA) or a vehicle terminal during a movement of the terminal. The service method of the DMB has three systems such as A, Dh, E, etc. The system A complies with the European digital broadcasting standard (OFDM) of the digital satellite broadcasting and the ground wave DMB. The system Dh represents a mixed method in which the satellite DMB is used with the ground wave DMB adapted as a basic part. The system E adapts the CDM similar with the CDMA.

The DMB may be served with the ground wave DMB and the satellite DMB.

The ground wave DMB basically represents a portable type multimedia broadcasting service using a 12^{th} channel in VHF, which is currently not used in Korea. Three blocks can be obtained by dividing one channel, with two video channels assigned to one block, with three to four audio channel assigned to one video channel. The ground wave DMB service will be basically served for vehicles for free.

In addition, the satellite DMB may be well adapted to an area which has bad conditions for receiving signals using a gap filler, with a satellite adapted to the satellite DMB different from the ground wave DMB. Totally 39 channels including 11 video channels, 25 audio channels, and 3 data channels will be served at first time at low cost.

However, the conventional digital multimedia broadcasting service does not have a certain system for charging the royalty of copyrights. In the case that various contents such as broadcasting music, images, etc. are directly stored (sound record, video record, etc.), there may be a big problem concerning the royalties between online service providers which provide the contents on the internet, persons having copyrights, and users.

### DISCLOSURE OF INVENTION

Accordingly, it is an object of the present invention to overcome the above-described problems encountered in the conventional art.

It is another object of the present invention to provide a system for charging a royalty of a copyright in a digital multimedia broadcasting and a method therefore, which are capable of recognizing an operation that users, which use a DMB (Digital Multimedia Broadcasting) through a receiving terminal, store a certain content such as a sound source, an image, etc. during a broadcasting or store the same based on a reservation and charging the above operation.

To achieve the above objects, there is provided a system for charging a copyright royalty in a digital multimedia broadcasting (DMB), comprising a DMB service provider computer which performs a broadcasting operation of various contents such as sound sources, images, etc. through a satellite or a repeater, and performs a copyright royalty charging process of each user based on a copyright royalty calculation information as a user, which receives a DMB provided from a charge process service provider, stores the contents; a receiving terminal which includes a key input unit which receives a key signal with respect to various functions of the receiving terminal, with the function including a function of storing contents such as sound sources, images, etc., which are being currently broadcasted, based on an operation of a user which uses a DMB service; a controller which controls an operation that various contents such as sound sources, images, etc. are received or outputted in accordance with a control of the DMB service provider computer, and controls an operation that the contents are stored in accordance with a control of the DMB service provider computer when a key signal for storing the contents such as sound sources, images, etc. is inputted from the key input unit or a previously reserved recording start time has come, and controls an operation that a charge data for paying a copyright royalty of the contents is generated in accordance with a user's operation when a key signal corresponding to a recording finish is inputted from the key input unit or a recording finish time has come, and controls an operation that a charge data generated for paying the copyright royalty is transmitted to the charge process service provider; a broadcasting signal receiving unit which receives various contents such as sound sources, images, etc. in accordance with a control of the controller, with the various contents being transmitted in accordance with a control of the DMB service provider; a display unit which displays a video data received through the broadcasting signal receiving unit on a screen in accordance with a control of the controller and displays the current operation state of the receiving terminal on the screen; an audio signal output unit which reproduces and outputs a sound source data received through the broadcasting signal receiving unit through speakers in accordance with a control of the controller; a storing unit which stores the contents such as sound sources, images, etc. received from the broadcasting signal receiving unit in accordance with a control of the controller and outputs a certain stored content in accordance with a request of the controller; a charge data generation unit which generates a charge data for paying a copyright royalty of the contents stored at the storing unit based on a subscriber information, a content storing time information, a channel information, a storing content ID, etc. in accordance with a control of the controller; and a charge data transceiver which transmits the charge data generated by the charge data generation unit to the charge process service provider computer through a communication network in accordance with a control of the controller; and a charge process service provider computer which receives a charge data, which is generated as a user stores a content such as sound sources, images, etc., from the receiving terminal through a communication network (return channel: a cellular phone communication network which performs a wireless internet and a short message service, a bi-directional pager network, a mobile internet (WiBro), etc), and calculates a copyright royalty paid by each user based on a charge data received from the receiving terminal, and transmits the calculated copyright royalty calculation information to the DMB service provider computer through a communication network.

There is provided a method for charging a copyright royalty in a digital multimedia broadcasting (DMB), comprising a step which a DMB service provider computer transmits a content such as sound sources, images, etc. to each receiving terminal, which is registered as a member, through a satellite or a repeater for an easier storing of the content; a step which the receiving terminal, which receives a content such as sound sources, images, etc. transmitted in accordance with a control of the DMB service provider computer, judges whether a recording start is selected in accordance with a user's key operation or a previously reserved recording start time has come; a step which when the recording start is selected in accordance with a user's key operation or the previously reserved recording start time has come, the receiving terminal stores a content such as sound sources, images, etc. transmitted in accordance with a control of the DMB service provider computer and at the same time generates a charge data for paying a copyright royalty; a step which the receiving terminal, which stores the contents of the current broadcasting, judges whether the recording finish is selected in accordance with a user's key operation or the previously reserved recording finish time has come; a step which when the recording finish is selected in accordance with a user's key operation or the previously reserved recording finish time has come, the receiving terminal generates a charge date, which is a basic information for paying a copyright royalty of the content stored by the user and transmits the generated charge data to the charge process service provider computer through a communication network (return channel: a cellular phone communication network which performs a wireless internet and a short message service, a bi-directional pager network, a mobile internet (WiBro), etc); a step which the charge process service provider computer, which received the charge data for paying a copyright royalty from the receiving terminal, calculates a copyright royalty paid by a user based on the charge data received from the receiving terminal and transmits the calculated copyright royalty calculation information to the DMB service provider computer through the communication network; and a step which the DMB service provider computer controls an operation that a copyright royalty of each user is charged based on the copyright royalty calculation information received from the charge process service provider computer and controls an operation that part of the profit is provided to the charge process service provider computer for the submission of the copyright royalty calculation information.

There is further provided method for charging a copyright royalty in a digital multimedia broadcasting, comprising a step which a DMB service provider computer transmits a content such as sound sources, images, etc. to each receiving terminal, which is registered as a member, through a satellite or a repeater for an easier storing of the content; a step which the receiving terminal, which receives the contents such as sound sources, images, etc. transmitted in accordance with a control of the DMB service provider computer, detects a storing (audio and video recordings) start key value, and recognizes a storing (audio and video recordings) object content, and stores the contents at a temporary storing region; a step which when a user's storing key input signal is received, and a storing (audio and video recordings) finish key value is detected from the contents such as sound sources, images, etc. of the current broadcasting, the receiving terminal generates a charge data for paying a copyright royalty of the contents such as sound sources, images, etc. transmitted in accordance with a control of the DMB service provider computer; a step which the generated charge data is transmitted to a charge process service provider computer through a communication network (return channel: a cellular phone communication network which performs a wireless internet and a short message service, a bi-directional pager network, a mobile internet (WiBro), etc); a step which when a receiving acknowledgment data of informing the receipt of a charge data is received from the charge process service provider computer, the receiving terminal finishes a charge data transmission process, and restores the contents such as sound sources, images, etc., which are stored at the temporary storing region, at a protection memory of the receiving terminal, and a storing success message is displayed on the screen; a step which the charge process service provider computer, which received the charge data for paying a copyright royalty from the receiving terminal, calculates a copyright royalty paid by each user based on the charge data received from the receiving terminal and transmits the calculated copyright royalty calculation information to the DMB service provider computer through a communication network; and a step which the DMB service provider computer controls a copyright royalty charging process of each user based on the copyright royalty calculation information received from the charge process service provider computer and provides part of the profit to the charge process service provider computer for the submission of the copyright royalty calculation information.

There is still further provided a method for charging a copyright royalty in a digital multimedia broadcasting, comprising a step which a user stores a reservation storing key value of a content selected using a content index (singer, song title, subject, etc.) at a receiving terminal based on an EPG, and a DMB service provider computer transmits the contents such as sound sources, images, etc. including a reservation storing key value to each receiving terminal, which is registered as a member, through a satellite or a repeater for an easier storing at each receiving terminal; a step which the receiving terminal, which receives the contents such as sound sources, images, etc. transmitted in accordance with a control of the DMB service provider computer, detects a storing (video and audio recordings) start key value included in the contents such as sound sources, images, etc., and recognizes as a storing (video and audio recordings) object content and stores the contents at a temporary storing region; a step which a reservation storing key value is detected from the contents such as sound sources, images, etc, and the detected key value is compared with a reservation storing key value previously stored by a user, and when the values are matched, a storing (video and audio recordings) finish key value is detected from the contents such as sound sources, images, etc. of the current broadcasting, the receiving terminal generates a charge data for paying a copyright royalty of the contents such as sound sources, images, etc. transmitted in accordance with a control of the DMB service provider computer; a step which the generated charge data is transmitted to the charge process service provider computer through a communication network (return channel: a cellular phone communication network which performs a wireless internet and a short message service, a bi-directional pager network, a mobile internet (WiBro), etc); a step which when a receiving acknowledgment data of informing the receipt of the charge data is received from the charge process service provider computer, the receiving terminal finishes the charge data transmission, and stores the contents such as sound sources, images, etc, which are stored at the temporary storing region, at a protection memory of the receiving terminal, and a storing success message is displayed on the screen; a step which the charge process service provider computer, which received the charge data for charging a copyright royalty from the receiving terminal, calculates a copyright royalty paid by each user based on the charge data received from the receiving terminal and transmits the calculated copyright royalty calculation information to the DMB service provider computer through a communication network; and a step which the DMB service provider computer controls a copyright royalty charging process of each user based on the copyright royalty calculation information received from the charge process service provider computer and provides part of the profit to the charge process service provider computer for the submission of the copyright royalty calculation information.

### BRIEF DESCRIPTION OF DRAWINGS

The present invention will become better understood with reference to the accompanying drawings which are given only by way of illustration and thus are not limitative of the present invention, wherein;

FIGS. 1A and 1B are schematic block diagrams illustrating a construction of a system for charging a royalty of a copyright in a digital multimedia broadcasting according to an embodiment of the present invention;

FIG. 2 is a block diagram illustrating a construction of a receiving terminal of FIG. 1;

FIG. 3 is a block diagram illustrating a construction of a charging process service provider computer of FIG. 1;

FIGS. 4A and 4B are flow charts of an operation of a method for charging a royalty of a copyright in a digital multimedia broadcasting according to the present invention;

FIGS. 5A and 5B are flow charts of an operation of a method for charging a royalty of a copyright in a digital multimedia broadcasting according to another embodiment of the present invention; and

FIGS. 6A and 6B are flow charts of an operation of a method for charging a royalty of a copyright in a digital multimedia broadcasting according to further another embodiment of the present invention.

### BEST MODE FOR CARRYING OUT THE INVENTION

A system for charging a royalty of a copyright in a digital multimedia broadcasting (DMB) and a method for the same according to the present invention will be described with reference to the accompanying drawings.

As shown therein, a DMB service provider computer 100 transmits various contents such as sound sources, images, etc. to each receiving terminal 200 through a satellite or repeater in accordance with a service environment of a satellite DMB or ground wave DMB, with each receiving terminal registered as a member. The DMB service provider computer 100 receives a copyright royalty calculation information for which users should pay, with the users directly storing various contents from a charge process service provider computer 300 into the receiving terminal 200 after the broadcasting is provided. In addition, the DMB service provider computer 100 controls a copyright royalty charging process of each user based on a copyright royalty calculation information provided from the charge process service provider computer 300.

When the copyright royalty charging process of each user is performed based on the copyright royalty calculation information provided from the charge process service provider computer 300, it is preferred that the DMB service provider computer 100 controls the above process. However, it is not limited thereto. Namely, an additional charging company may perform the above operation.

The receiving terminal 200 receives and outputs various contents such as sound sources, images, etc. in accordance with a control of the DMB service provider computer 100. In the case that the user stores the contents such as sound sources, images, etc. during the broadcasting or stores the same based on the reservation, the receiving terminal 200 generates a charge data for a copyright royalty based on the storage of the contents in accordance with a subscriber information, a content storing time information, a channel information, a storing content ID, etc. and transmits the generated charge data to the charge process service provider computer 300, which performs a copyright royalty calculation process, through a certain communication network (a mobile telephone communication network, a bi-directional pager network, a mobile internet (WiBro), etc.).

Namely, the receiving terminal 200 generates a charge data for a copyright royalty payment based on the storage of the contents unless the user performs a certain operation and transmits to the charge process service provider computer 300, with the charge data being generated based on a subscriber information, a content storing time information, a channel information, a storing content ID, etc.

At this time, the charge data, which are generated by the receiving terminal 200 based on the storage of the contents such as sound sources, image, etc. and transmitted to the charge process service provider computer 300, includes a subscriber information, a content storing time information, a channel information, a storing content ID, etc., and the contents included on the charge data may be changed depending on the demands of the DMB service providers.

In addition, the charge data are transmitted from the receiving terminal 200 to the charging process service provider computer 300 are using various communication networks (return channels) such as a cellular phone communication network which performs a wireless internet, short message transmission, etc., a bi-directional pager network, a mobile internet (WiBro).

The receiving terminal 200 may be designed to store the contents only when there is provided a certain channel (classified with a channel number or a separate download flag) transmitted in accordance with a control of the DMB service provider computer 100. Namely, in the charged channel, the service is not provided unless the user is registered to the charged service. Namely, the contents may be stored with respect to a certain channel.

The receiving terminal 200 may adapt a DRM solution so that a reproduction can be performed by a corresponding receiving terminal 200 when a certain content transmitted is stored in accordance with the DMB service provider computer 100.

The adaptation of the DRM solution may be performed by an encoding or decoding method with respect to an ID (telephone number, ESN, other device_ID, etc) of the terminal.

The receiving terminal 200 may have an EPG (electronic Program Guide) in which a broadcasting program of a desired date is searched using a wireless internet, etc. when a user stores a certain content based on a reservation function, and a reservation storing can be performed based on a corresponding reservation time information and a reservation storing key value when a desired content is designated. For example, when a user connects with an EPG service providing site with a wireless internet and selects a desired storing content after searching a desired date, time, program, etc., the reservation time information or reservation storing key value of each content is transmitted from the EPG service providing site and is stored in the receiving terminal 200. When a reservation time is matched, and a reservation storing key value included in the contents during broadcasting is matched, so that the reservation storing function is performed.

In addition, the receiving terminal 200 may classify and store each content at a separate file with respect to a certain separator of one content and the next content when storing more than one content in accordance with a user's operation. For example, when a user wants to store 10 song titles for one hour with a reservation function, the contents corresponding to 10 song titles are not stored in one file (in the format of MP3, etc), but the contents corresponding to the 10 song titles are stored in each file (in the format of MP3, etc) based on the separator provided between the 10 song title contents which are broadcasted for one hour.

The charge process service provider computer 300 receives a charge data generated based on a subscriber information, a content storing time information, a channel information, a storing content ID, etc. as the contents such as a user's sound source, images, etc. are inputted from the receiving terminal 200 through a communication network (a cellular phone communication network, a bi-directional network, a mobile internet (WiBro), etc.) and are stored. A copyright royalty, which each user pays based on the charge data received from the receiving terminal 200, is calculated. The calculated copyright royalty calculation information is transmitted to the DMB service provider computer 300 through various wired or wireless communication networks.

At this time, the charge process service provider computer 300 receives part of the copyright royalty paid by the user, which stores the contents such as sound sources, images, etc. from the DMB service provider computer 100, as service charge for providing the charge process information.

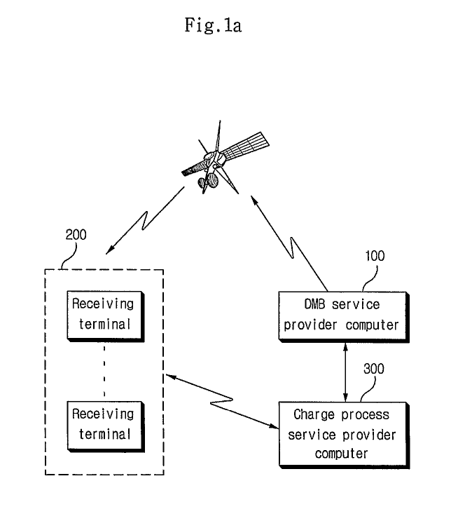

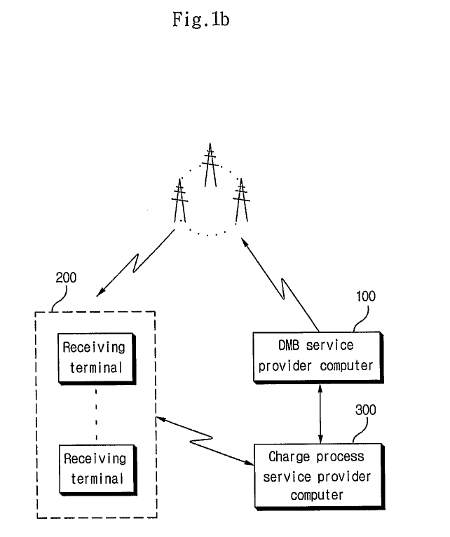

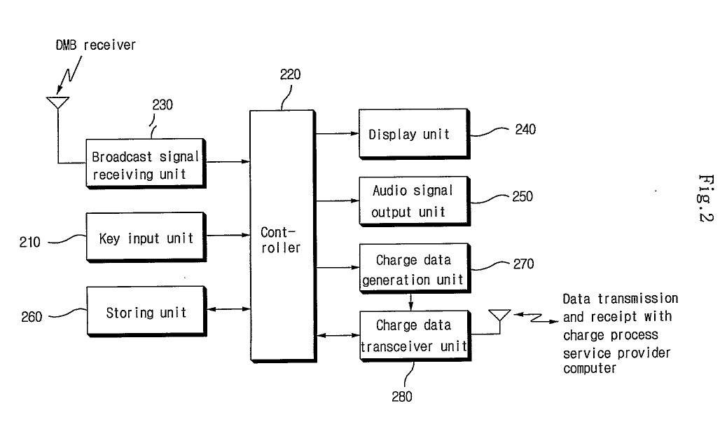

FIG. 2 is a block diagram illustrating the construction of the receiving terminal 200 of FIG. 1.

As shown therein, the key input unit 210 outputs key signals (for example, power operation key signal, recording key signal for storing contents such as sound sources during broadcasting, images, etc.) with respect to various functions of the receiving terminal 200 to the controller 220 in accordance with an operation of a user, which uses a digital multimedia broadcasting service.

The controller 220 controls the operations that various contents such as sound sources, images, etc. are received into the broadcasting signal receiving unit 230 in accordance with a control of the DMB service provider computer 100 and are outputted through the display unit 240 and the audio signal output unit 250. In addition, the controller 200 controls the operations that when a key signal is inputted from the key input unit 210 for storing the contents such as sound sources, images, etc. or the reservation storing key value previously stored in the receiving terminal 200 is matched with the reservation storing key value included in the contents such as sound sources, images, etc., the contents are stored in the storing unit 260 in accordance with a control of the DMB service provider computer 100.

In addition, the controller 220 controls the operations that when the contents are stored or recorded, the charge data generation unit 270 generates a charge data for paying the copyright royalty of the contents stored in accordance with an operation of the user, and the charge data generated for paying the copyright royalty is transmitted to the charge process service provider computer 300 through the charge data transceiver 280.

At this time, the controller 220 finishes a charge data transmission operation when a receiving acknowledgement data (ACK signal) is received from the charge process service provider computer 300, with the receiving acknowledgement data being adapted to inform an operation that the charge data, which are generated by the charge data generation unit 270 based on a subscriber information, a content storing time information, a channel information, a storing content ID, etc. as the contents such as sound sources, images, etc. are stored based on a user's key operation, are transmitted to the charge process service provider computer 300 through the charge data transceiver 280, and are received. In addition, the controller 220 controls the operations that the charge data are retransmitted to the charge data service provider computer 300 at certain time intervals by the set number when the charge process service provider computer 300 does not receive the receiving acknowledgement data, with the charge data generated based on a subscriber information, a content storing time information, a channel information, a storing content ID, etc. by the charge data generation unit 270 being transmitted to the charge process service provider computer 300 through the charge data transceiver 280, and with the receipt of the charge data being acknowledged.

In accordance with a control of the controller 220, the broadcast signal receiving unit 230 receives various contents such as sound sources, images, etc. transmitted through a satellite or repeater in accordance with a control of the DMB service provider computer 100.

The display unit 240 displays the image data received through the broadcast signal receiving unit 230 in accordance with a control of the controller 220 and displays the current operation state of the receiving terminal 200, so that the user confirms the above operations.

The audio signal output unit 250 outputs through the speakers the sound source data received through the broadcast signal receiving unit 230 in accordance with a control of the controller 220.

The storing unit 260 stores the contents such as sound sources, images, etc. received through the broadcast signal receiving unit 230 in accordance with a control of the controller 220 and outputs a certain content in accordance with a request from the controller 220.

The charge data generation unit 270 generates a charge data for paying a copyright royalty of the contents stored in the storing unit 260 based on a subscriber information, a content storing time information, a channel information, a storing content ID, etc. in accordance with a control of the controller 220.

The charge data transceiver 280 transmits a charge data generated by the charge data generation unit 270 to the charge process service provider computer 300 through a communication network (return channel: cellular phone communication network which performs wireless internet and short message transmission, bi-directional pager network, mobile internet (WiBro), etc).

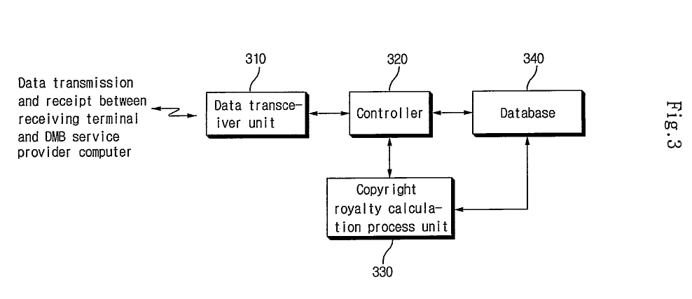

FIG. 3 is a block diagram illustrating the construction of the charge process service provider computer 300 of FIG. 1.

As shown therein, the data transceiver 310 receives a charge data generated based on a subscriber information, a content storing time information, a channel information, a storing ID, etc. based on the storage of the contents such as sound sources, images, etc. by the user from the receiving terminal 200 through the communication network and outputs to the controller 320. The data transceiver 310 transmits a receiving acknowledgement data to the receiving terminal 200, with the receiving acknowledgment data being adapted to inform the receipt of the charge data from the controller 320. The data transceiver 310 transmits a copyright royalty calculation information of each user calculated based on the charge data received from the receiving terminal 200 to the DMB service provider computer 100 in accordance with a control of the controller 320 and receives a receiving acknowledgement data from the DMB service provider computer 100 and outputs to the controller 320, with the receiving acknowledgement data being adapted to inform the receipt of the copyright royalty calculation information of each user.

The controller 320 controls the operations that a calculation of copyright royalty paid by each user is performed and stored based on a charge data received from the receiving terminal 200 through the data transceiver 310, and the copyright royalty charge process information paid by each user is transmitted to the DMB service provider computer 100 through the data transceiver 310.

The copyright royalty calculation process unit 330 calculates a copyright royalty paid by each user based on the charge data received from the receiving terminal 200 through the data transceiver 310 in accordance with a control of the controller 320.

The database 340 stores a broadcast program information and a copyright royalty information with respect to the contents such as sound sources, images, etc., which are transmitted in accordance with a control of the DMB service provider computer 100 and stores a copyright royalty information of each user calculated by the copyright royalty calculation process unit 330 in accordance with a control of the controller 320.

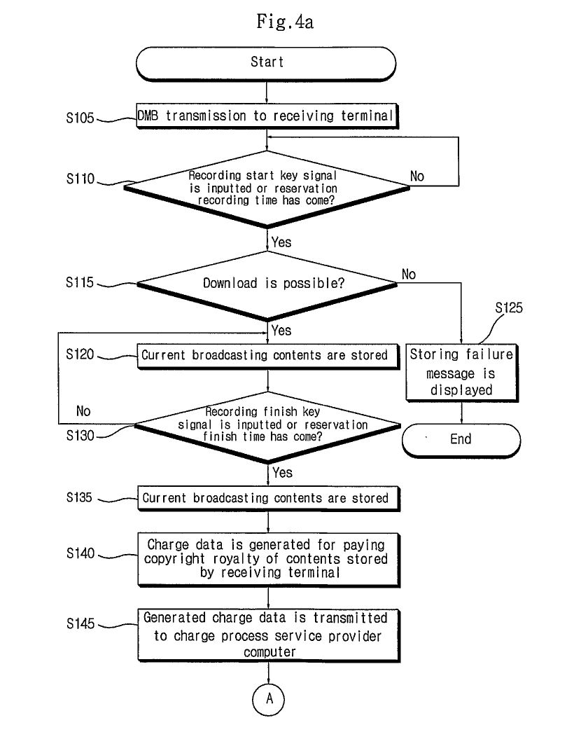

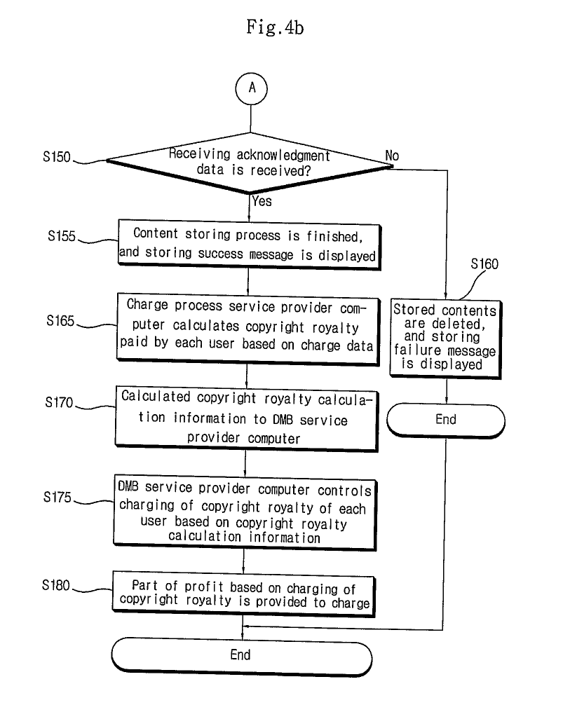

The method for charging a copyright royalty in a digital multimedia broadcast according to the present invention will be described with reference to FIGS. 4A and 4B.

FIGS. 4A and 4B are flow charts of an operation of a method for charging a copyright royalty in a digital multimedia broadcast according to the present invention.

The contents such as sound sources, images, etc. are transmitted and stored in the receiving terminal 200 of each user which uses a digital multimedia broadcast service through a satellite or a repeater in accordance with a control of the DMB service provider computer 100 in a step S105.

The receiving terminal 200 judges whether a recording start is selected or a previously reserved recording start time has come based on a user's key operation in the current broadcast state in accordance with a control of the DMB service provider computer 100 in a step S110.

As a result of the judgment, when the recording start is selected or the previously reserved recording start time has come based on a user's key operation, the receiving terminal 200 judges whether a download of a corresponding content is possible or not in a step S115.

As a result of the judgment, as a result of the judgment, if the download of a corresponding content is possible, the receiving terminal 200 stores the contents such as sound sources, images, etc. in accordance with a control the DMB service provider computer 100 and generates a charge data for paying a copyright royalty based on a subscriber information, a content storing time information, a channel information, a storing content ID, etc. in a step S120.

However, as a result of the judgment of the step S115, if the download of corresponding content is impossible, the receiving terminal 200 displays a storing impossible message on the screen, so that a user recognizes in a step S125.

The receiving terminal 200, which stores the contents of the current broadcast, judges whether the recording finish is selected or the previously reserved recording finishing time has come based on a user's key operation in a step S130.

As a result of the judgment, if the recording finish is selected or the previously reserved recording finishing time has come based on a user's key operation, the receiving terminal 200 stores the contents, which is currently being broadcasted in a step S135. The receiving terminal 200 generates a charge data, which is a basic information for paying a copyright royalty of the content stored by the user, based on a subscriber information, a content storing time information, a channel information, a storing content ID, etc. in a step S140.

The receiving terminal 200 transmits a charge data generated based on a subscriber information, a content storing time information, a channel information, a storing content ID, etc., as the contents are stored, to the charge process service provider computer 300 through a communication network (return channel: cellular phone communication network which performs a wireless internet and a short message service, bi-directional pager network, mobile internet (WiBro), etc) in a step S145 and judges whether a receiving acknowledgment data is received or not, with the receiving acknowledgment data being adapted to inform the receipt of the charge data from the charge process service provider computer 300 in a step S150.

As a result of the judgment, the receiving terminal 200 finishes the storing operation of the contents and displays the success of the storing when the receiving acknowledgment data in a step S155, which informs the receipt of the charge data from the charge process service provider computer 300, is received, with the charge data being generated based on a subscriber information, a content storing time information, a channel information, a storing content ID, etc., as the contents are stored by the user and being transmitted to the charge process service provider computer 300.

As a result of the judgment of the step S150, if the receiving acknowledgment data, which informs the receipt of the charge data, is not received from the charge process service provider computer 300, the receiving terminal 200 retransmits the charge data to the charge process service provider computer 300 at regular time intervals by set number. If the receiving acknowledgment data is not finally received, the stored contents are deleted, and a storing failure message is displayed on the screen in a step S160.

The charge process service provider computer 300, which received the charge data for paying a copyright royalty from the receiving terminal 200, calculates the copyright royalty based on the charge data from the receiving terminal 200, with the charge data being paid by each user, in a step S165. Namely, the copyright royalty that a corresponding user pays is calculated based on a comparison between the content information and the charge data received from the receiving terminal 200 in accordance with a control of the DMB service provider computer 100.

The charge process service provider computer 300 transmits the calculated copyright royalty calculation information to the DMB service provider computer 100 through various wireless communication networks in a step S170.

The DMB service provider computer 100, which received the copyright royalty calculation information paid each user from the charge process service provider computer 300, controls a copyright royalty charging process of each user based on the copyright royalty calculation information received from the charge process service provider computer 300 in a step S175.

The DMB service provider computer 100 provides part of copyright royalty profit paid by each user to the charge process service provider computer 300 in a step S180.

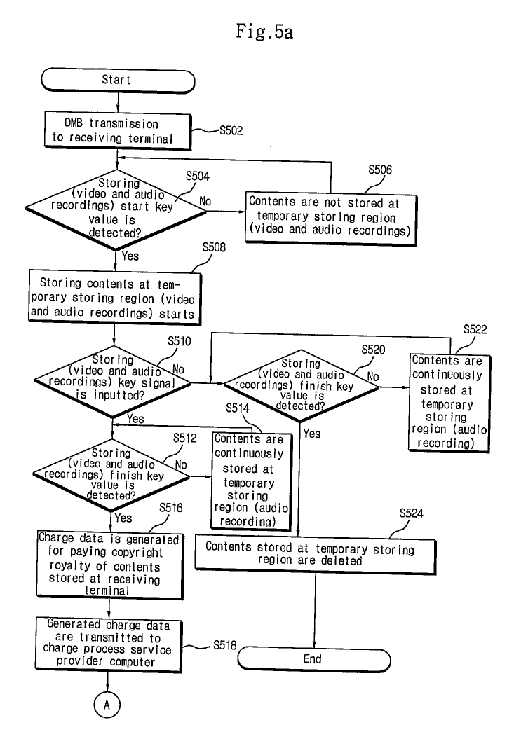

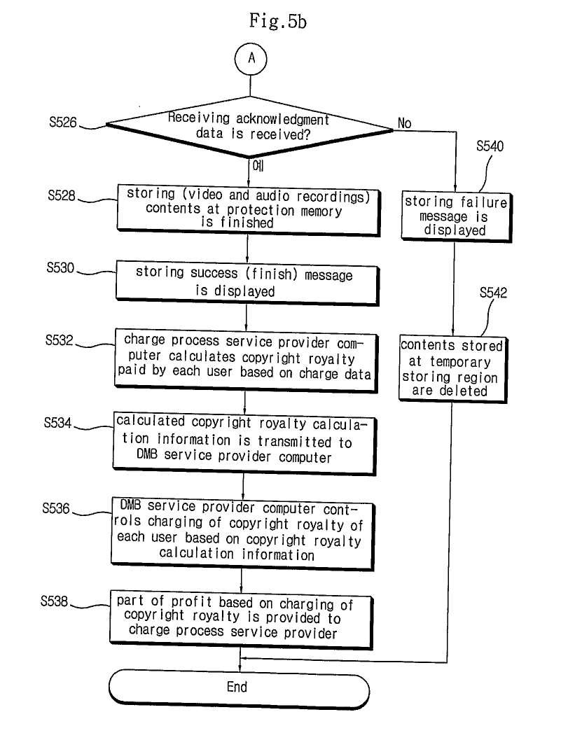

Next, the method for charging a copyright royalty in a digital multimedia broadcast according to another embodiment of the present invention will be described with reference to FIGS. 5A and 5B.

FIGS. 5A and 5B are flow charts of an operation of a method for charging a copyright royalty in a digital multimedia broadcast according to another embodiment of the present invention.

As shown therein, the contents such as sound sources, images, etc. are transmitted to the receiving terminal 200 of the user which uses a digital multimedia broadcast service through a satellite or a repeater in accordance with a control of the DMB service provider computer 100 in a step S502.

The receiving terminal 200, which receives the contents such as sound sources, images, etc., detects a storing (audio and video recordings) start key value included in the contents such as sound sources, images, etc. in a step S504 and recognizes a storing (audio and video recordings) object content and stores the contents at a temporary storing region in a step S508.

If the storing (audio and video recordings) start key value is not detected in the contents, the video and audio contents are not stored at a temporary storing region in a step S506.

If there is a storing key signal inputted by the user in a step S510, and the storing (video and audio recordings) finish key value included in the contents such as sound sources, images, etc. of the current broadcast is detected in a step S512, while the contents such as sound sources, images, etc. are being continuously stored (video and audio recordings) at a temporary storing region, the receiving terminal 200 generates a charge data based on a subscriber information, a content storing time information, a channel information, a storing content ID, etc. for paying a copyright royalty of the contents such as sound sources, images, etc. in accordance with a control of the DMB service provider computer 100 in a step S516.

If there is not a storing key signal inputted by a user (S510), and the storing (audio and video recordings) finish key value included in the contents such as sound sources, images, etc. of the current broadcast is detected in a step S520, while the contents such as sound sources, images, etc. are being continuously stored at a temporary storing region (audio and video recordings), the contents stored at the temporary region are deleted in a step S524.

The receiving terminal 200 transmits a charge data generated for paying a copyright royalty to the charge process service provider computer 300 through a communication network (return channel: cellular phone communication network which performs wireless internet and short message service, bi-directional pager network, mobile internet (WiBro), etc) in a step S518 and judges whether the receiving acknowledgment data is received from the charge process service provider computer 300 with the receiving acknowledgment data being adapted to inform the receipt of the charge data in a step S526.

When the receiving acknowledgment data of informing the receipt of the charge data is received from the charge process service provider computer 300, the receiving terminal 200 restores the contents such as sound sources, images, etc., which are stored at the temporary storing region, at a protection memory, and the success of the data storing is displayed on the screen in a step S530.

However, if the receiving acknowledgment data of informing the receipt of the charge data is not received from the charge process service provider computer 300, the receiving terminal 200 retransmits the charge data to the charge process service provider computer 300 at regular intervals for set number. If the receipt of the receiving acknowledgement data is not confirmed within the set numbers of the transmission, the receiving terminal 200 finishes the charge data transmission, and displays the storing failure message on the screen in a step S540, and the contents such as sound sources, images, etc. stored at the temporary storing region are deleted in a step S542.

The charge process service provider computer 300, which received the copyright royalty from the receiving terminal 200, calculates the copyright royalty paid by each user based on the charge data received from the receiving terminal 200 in a step S532. Namely, the copyright royalty paid by each user is calculated based on a comparison between the broadcasting content information and the charge data received from the receiving terminal 200 in accordance with a control of the DMB service provider computer 100.

The charge process service provider computer 300 transmits the calculated copyright royalty calculation information to the DMB service provider computer 100 through various wired or wireless communication networks in a step S534.

The DMB service provider computer 100, which received the copyright royalty calculation information paid by each user from the charge process service provider computer 300, controls a charging operation of the copyright royalty of each user based on the copyright royalty calculation information received from the charge process service provider computer 300 in a step S536.

The DMB service provider computer 100 provides part of the copyright royalty profit paid by each user to the charge process service provider computer 200 for the submission of the copyright royalty calculation information in a step S538.

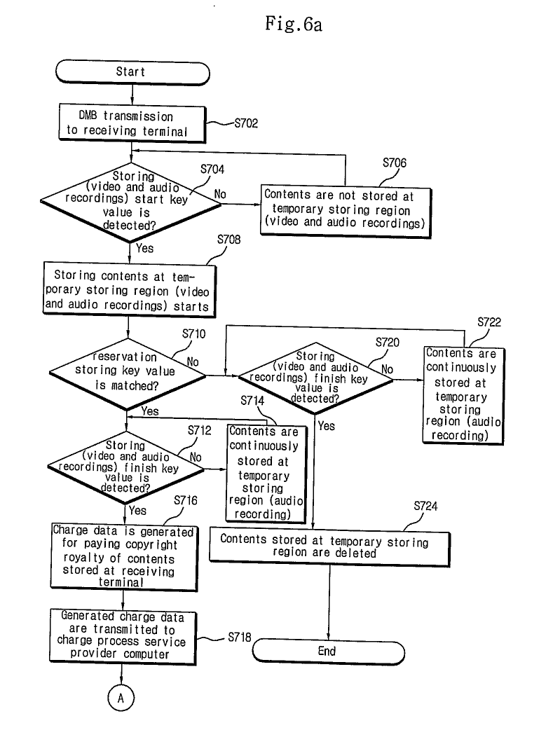

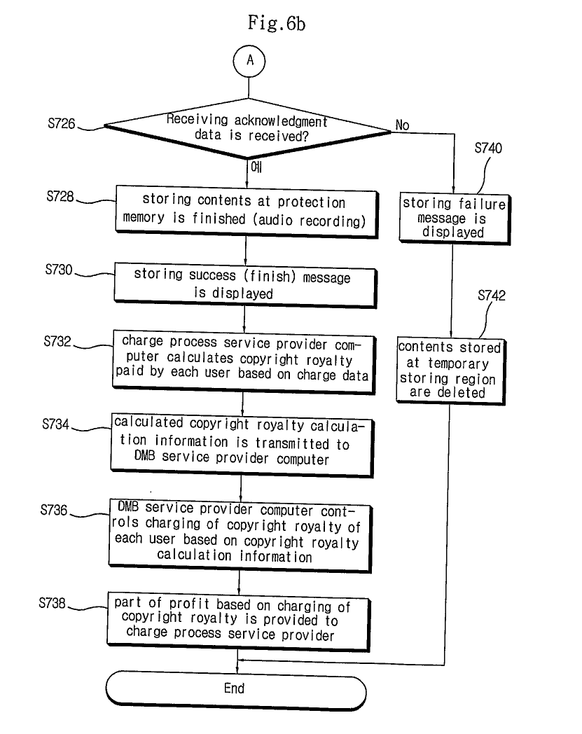

FIGS. 6A and 6B are flow charts of an operation of a method for charging a copyright royalty in a digital multimedia broadcast according to further another embodiment of the present invention.

As shown therein, a reservation storing key value of the contents which a user selected using a content index (singer, song title, subject, etc) based on the EPG is stored at the receiving terminal 200. The contents such as sound sources, images, etc. are transmitted and stored at the receiving terminal of each user, which uses a digital multimedia broadcasting service through a satellite or a repeater, in accordance with a control of the DMB service provider computer 100 in a step S702.

The receiving terminal 200, which receives the contents such as sound sources, images, etc, detects a storing (video and audio recordings) start key value included in the contents such as sound sources, images, etc. in accordance with a control of the DMB service provider computer 100 in a step S704 and recognizes the contents as a storing (audio and video recordings) object content, and the contents are stored at a temporary storing region in a step S708.

If the storing (audio and video recordings) start key value is not detected from the contents, the contents are not stored (recorded) in a step S706.

If the reservation storing key value contained in the contents such as sound sources, images, etc. is detected while the contents such s sound sources, images, etc. are being continuously stored at the temporary storing region, and the reservation storing key value is matched with the reservation storing key value which the user previously stored in a step S710, the receiving terminal 200 generates a charge data based on a subscriber information, a content storing time information, a channel information, a storing content ID, etc. for paying a copyright royalty of the contents such as sound sources, images, etc. in accordance with a control of the DMB service provider computer 100 in a step S716 after the storing (audio and video recordings) finish key value contained in the contents such as sound sources, images, etc. of the current broadcasting is detected in a step S712.

If the reservation storing key value is not stored by the user or the stored reservation storing key value is different from the reservation storing key value included in the contents of the current broadcasting in a step S710, while the contents such as sound sources, images, etc, are being continuously stored at the temporary storing region (audio and video recordings), when the storing (audio and video recordings) finish key value is detected from the contents such as sound sources, images, etc. of the current broadcasting in a step S720, the contents stored in the temporary storing region is deleted in a step S724.

The receiving terminal 200 transmits a charge data generated for paying the copyright royalty to the charge process service provider computer through a communication network (return channel: cellular phone communication network which performs wireless internet and short message service, bi-directional pager network, mobile internet (WiBro), etc) in a step S718 and judges whether the receiving acknowledgment data of informing the receipt of the charge data is received from the charge process service provider computer 300 in a step S726.

When the receiving acknowledgment data of informing the receipt of the charge data is received from the charge process service provider computer 300, the receiving terminal 200 restores the contents such as sound source, images, etc., which are stored at the temporary storing region, at a certain protection memory in a step S728, and the success storing message is displayed on the screen in a step S730.

However, if the receiving acknowledgment data of informing the receipt of the charge data is not received from the charge process service provider computer 300, the receiving terminal 200 retransmits the charge data to the charge process service provider computer 300 at regular intervals by set numbers. If the receiving acknowledgment data is not finally received within the set numbers, the receiving terminal 200 finishes the charge data transmission and displays the storing failure message on the screen in a step S740. The contents such as sound sources, images, etc stored at the temporary storing region are deleted, and the routine is finished in a step S742.

Now, the charge process service provider computer 300, which received the charge data for paying the copyright royalty from the receiving terminal 200, calculates the copyright royalty paid by each user based on the charge data received from the receiving terminal 200 in a step S732. Namely, the charge process service provider computer 300 calculates the copyright royalty paid by a corresponding user based on a comparison between the broadcasting content information and the charge data received from the receiving terminal 200 in accordance with a control of the DMB service provider computer 100.

The charge process service provider computer 300 transmits the calculated copyright royalty calculation information to the DMB service provider computer 100 through various wired and wireless communication networks in a step S734.

The DMB service provider computer 100, which received the copyright royalty calculation information paid by each user from the charge process service provider computer 300, controls a copyright royalty charging process of each user based on the copyright royalty calculation information received from the charge process service provider computer 300 in a step S736.

The DMB service provider computer 100 provides part of the copyright royalty profit paid by each user to the charge process service provider computer 300 for the submission of the copyright royalty calculation information in a step S738.

### INDUSTRIAL APPLICABILITY

As described above, in the system for charging a copyright royalty in a digital multimedia broadcast and a method for the same according to the present invention, when a user stores a certain content such as sound sources, images, etc. at a receiving terminal based on a user's storing operation or a previous reservation operation while the user receives a digital multimedia broadcast using a receiving terminal, a charge process calculation of a copyright royalty paid by a user can be performed based on a subscriber information, a content storing time information, a channel information, a storing content ID, etc. unless a user or DMB service provider performs an additional operation for charging the same.

In addition, in the present invention, the charging operation of the copyright royalty based on content storing operations by users is automatically performed based on a subscriber information, a content storing time information, a channel information, a storing content ID, etc., so that it is possible to prevent any dispute between a user and a service provided which are related with a copyright royalty. In addition, the copyright royalty profits of the DMB service provider, which provides a digital multimedia broadcast service, a copyright owner, a charge process service provider, etc. may increase.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A system for charging a copyright royalty in a digital multimedia broadcasting (DMB), comprising:
a DMB service provider computer which performs a broadcasting operation of various contents such as sound sources, images, etc. through a satellite or a repeater, and performs a copyright royalty charging process of each user based on a copyright royalty calculation information as a user, which receives a DMB provided from a charge process service provider, stores the contents;
a receiving terminal which includes:
a key input unit which receives a key signal with respect to various functions of the receiving terminal, with said function including a function of storing contents such as sound sources, images, etc., which are being currently broadcasted, based on an operation of a user which uses a DMB service;
a controller which controls an operation that various contents such as sound sources, images, etc. are received or outputted in accordance with a control of the DMB service provider computer, and controls an operation that the contents are stored in accordance with a control of the DMB service provider computer when a key signal for storing the contents such as sound sources, images, etc. is inputted from the key input unit or a previously reserved recording start time has come, and controls an operation that a charge data for paying a copyright royalty of the contents is generated in accordance with a user's operation when a key signal corresponding to a recording finish is inputted from the key input unit or a recording finish time has come, and controls an operation that a charge data generated for paying the copyright royalty is transmitted to the charge process service provider;
a broadcasting signal receiving unit which receives various contents such as sound sources, images, etc. in accordance with a control of the controller, with said various contents being transmitted in accordance with a control of the DMB service provider;
a display unit which displays a video data received through the broadcasting signal receiving unit on a screen in accordance with a control of the controller and displays the current operation state of the receiving terminal on the screen;
an audio signal output unit which reproduces and outputs a sound source data received through the broadcasting signal receiving unit through speakers in accordance with a control of the controller;
a storing unit which stores the contents such as sound sources, images, etc. received from the broadcasting signal receiving unit in accordance with a control of the controller and outputs a certain stored content in accordance with a request of the controller;
a charge data generation unit which generates a charge data for paying a copyright royalty of the contents stored at the storing unit based on a subscriber information, a content storing time information, a channel information, a storing content ID, etc. in accordance with a control of the controller; and
a charge data transceiver which transmits the charge data generated by the charge data generation unit to the charge process service provider computer through a communication network in accordance with a control of the controller; and
a charge process service provider computer which receives a charge data, which is generated as a user stores a content such as sound sources, images, etc., from the receiving terminal through a communication network (return channel: a cellular phone communication network which performs a wireless internet and a short message service, a bi-directional pager network, a mobile internet (WiBro), etc), and calculates a copyright royalty paid by each user based on a charge data received from the receiving terminal, and transmits the calculated copyright royalty calculation information to the DMB service provider computer through a communication network.

2. The system of claim 1, wherein said controller controls the operations that a charge data generated based on a subscriber information, a content storing time information, a channel information, a storing content ID, etc. is transmitted from the charge data generation unit to the charge process service provider computer through the charge data transceiver as a content such as sound sources, images, etc. is stored based on a user's key operation or reservation, and a charge data transmission is finished when a receiving acknowledgment data of informing the receipt of the charge data is received into the charge process service provider computer, and when the receiving acknowledgment data of informing the receipt of the same is not received into the charge process service provider computer after the charge data generated by the charge data generation unit is transmitted to the charge process service provider computer through the charge data transceiver, the charge data is retransmitted to the charge process service provider computer at regular intervals by set numbers.

3. The system of claim 1, wherein said charge process service provider computer includes:
a data transceiver which receives a charge data generated as a user stores a content such as sound sources, images, etc. received from the receiving terminal through a communication network, and transmits a receiving acknowledgment data of informing the receipt of the charge data to the receiving terminal, and transmits a copyright royalty calculation information of each user calculated based on the charge data received from the receiving terminal to the DMB service provider computer, and receives the receiving acknowledgment data of informing the receipt of the copyright royalty calculation information of each user from the DMB service provider computer;
a controller which controls the operation that a copyright royalty paid by each user is calculated and stored based on the charge data received from the receiving terminal through the data transceiver, and the copyright royalty charge process information paid by each user is transmitted to the DMB service provider computer through the data transceiver;
a copyright royalty calculation process unit which calculates the copyright royalty paid by each user based on the charge data received from the receiving terminal in accordance with a control of the controller; and
a database which stores a broadcast program information and a copyright royalty information with respect to the contents such as sound sources, images, etc. outputted in accordance with a control of the DMB service provider computer, and stores a copyright royalty calculation information of each user calculated by the copyright royalty calculation process unit in accordance with a control of the controller.

4. The system of claim 1, wherein said receiving terminal is designed to store the contents only with respect to a certain channel (classified with channel number or classified by an additional download flag) transmitted in accordance with a control of the DMB service provider computer.

5. The system of claim 1, wherein said receiving terminal adapts a DRM solution so that a certain content is outputted only from a corresponding receiving terminal when the content transmitted in accordance with a control of the DMB service provider computer is stored.

6. The system of claim 1, wherein said receiving terminal includes an EPG (Electronic Program Guide) function which inquires a broadcasting program schedule of a certain date using a wireless internet when a user stores a certain content with a reservation, and performs a reservation and storing operation based on a corresponding time information when a desired content is designated.

7. The system of claim 1, wherein said receiving terminal classifies each content with a certain file with respect to a separator between one content and the next content when storing more than one content based on a user's operation.

8. A method for charging a copyright royalty in a digital multimedia broadcasting (DMB), comprising:
(1) a step which a DMB service provider computer transmits a content such as sound sources, images, etc. to each receiving terminal, which is registered as a member, through a satellite or a repeater for an easier storing of the content;
(2) a step which the receiving terminal, which receives a content such as sound sources, images, etc. transmitted in accordance with a control of the DMB service provider computer, judges whether a recording start is selected in accordance with a user's key operation or a previously reserved recording start time has come;
(3) a step which when the recording start is selected in accordance with a user's key operation or the previously reserved recording start time has come, the receiving terminal stores a content such as sound sources, images, etc. transmitted in accordance with a control of the DMB service provider computer and at the same time generates a charge data for paying a copyright royalty;
(4) a step which the receiving terminal, which stores the contents of the current broadcasting, judges whether the recording finish is selected in accordance with a user's key operation or the previously reserved recording finish time has come;
(5) a step which when the recording finish is selected in accordance with a user's key operation or the previously reserved recording finish time has come, the receiving terminal generates a charge date, which is a basic information for paying a copyright royalty of the content stored by the user and transmits the generated charge data to the charge process service provider computer through a communication network (return channel: a cellular phone communication network which performs a wireless internet and a short message service, a bi-directional pager network, a mobile internet (WiBro), etc);
(6) a step which the charge process service provider computer, which received the charge data for paying a copyright royalty from the receiving terminal, calculates a copyright royalty paid by a user based on the charge data received from the receiving terminal and transmits the calculated copyright royalty calculation information to the DMB service provider computer through the communication network; and
(7) a step which the DMB service provider computer controls an operation that a copyright royalty of each user is charged based on the copyright royalty calculation information received from the charge process service provider computer and controls an operation that part of the profit is provided to the charge process service provider computer for the submission of the copyright royalty calculation information.

9. The method of claim 8, wherein when the receiving terminal stores a content such as sound sources, images, etc. based on a user's key operation or a previously reserved operation in the step (5), the generated charge data includes a subscriber information, a start information, a finish time, a channel information, a storing content information, etc.

10. The method of claim 8, wherein said charge data transmitted from the receiving terminal to the charge process service provider computer in the step (5) is transmitted through various return channels (communication network) such as a cellular phone communication network which performs a wireless internet and a short message service, a bi-directional pager network, a mobile internet, etc.

11. The method of claim 8, wherein said receiving terminal which transmits the charge data generated based on the storing of the contents by the user in the step (5) to the charge process service provider computer finishes a charge data transmission when a receiving acknowledgment data of informing the receipt of the charge data is received from the charge process service provider computer; and when the receiving acknowledgment data of informing the receipt of the charge data is not received from the charge process service provider computer, the charge data is retransmitted to the charge process service provider at regular time intervals by set numbers.

12. A method for charging a copyright royalty in a digital multimedia broadcasting, comprising:
(1) a step which a DMB service provider computer transmits a content such as sound sources, images, etc. to each receiving terminal, which is registered as a member, through a satellite or a repeater for an easier storing of the content;
(2) a step which the receiving terminal, which receives the contents such as sound sources, images, etc. transmitted in accordance with a control of the DMB service provider computer, detects a storing (audio and video recordings) start key value, and recognizes a storing (audio and video recordings) object content, and stores the contents at a temporary storing region;
(3) a step which when a user's storing key input signal is received, and a storing (audio and video recordings) finish key value is detected from the contents such as sound sources, images, etc. of the current broadcasting, the receiving terminal generates a charge data for paying a copyright royalty of the contents such as sound sources, images, etc. transmitted in accordance with a control of the DMB service provider computer;
(4) a step which the generated charge data is transmitted to a charge process service provider computer through a communication network (return channel: a cellular phone communication network which performs a wireless internet and a short message service, a bi-directional pager network, a mobile internet (WiBro), etc);
(5) a step which when a receiving acknowledgment data of informing the receipt of a charge data is received from the charge process service provider computer, the receiving terminal finishes a charge data transmission process, and restores the contents such as sound sources, images, etc., which are stored at the temporary storing region, at a protection memory of the receiving terminal, and a storing success message is displayed on the screen;
(6) a step which the charge process service provider computer, which received the charge data for paying a copyright royalty from the receiving terminal, calculates a copyright royalty paid by each user based on the charge data received from the receiving terminal and transmits the calculated copyright royalty calculation information to the DMB service provider computer through a communication network; and
(7) a step which the DMB service provider computer controls a copyright royalty charging process of each user based on the copyright royalty calculation information received from the charge process service provider computer and provides part of the profit to the charge process service provider computer for the submission of the copyright royalty calculation information.

13. The method of claim 12, wherein said step (3) further includes a step which when there is not a user's storing key input signal, and a storing (audio and video recordings) finish key value is detected from the contents such as sound sources, images, etc. of the current broadcasting, the contents such as sound sources, images, etc. stored at the temporary storing region are deleted.

14. The method of claim 12, wherein said step (5) further includes a step which when the receiving acknowledgment data of informing the receipt of the charge data is not received from the charge process service provider computer, the receiving terminal retransmits the charge data to the charge process service provider computer at regular time intervals by set numbers, and when the receiving acknowledgment data is not finally received within the set numbers, the receiving terminal finishes the charge data transmission, and displays a storing failure message on the screen, and the contents such as sound sources, images, etc. stored at the temporary storing region are deleted.

15. A method for charging a copyright royalty in a digital multimedia broadcasting, comprising:
(1) a step which a user stores a reservation storing key value of a content selected using a content index (singer, song title, subject, etc.) at a receiving terminal based on an EPG, and a DMB service provider computer transmits the contents such as sound sources, images, etc. including a reservation storing key value to each receiving terminal, which is registered as a member, through a satellite or a repeater for an easier storing at each receiving terminal;
(2) a step which the receiving terminal, which receives the contents such as sound sources, images, etc. transmitted in accordance with a control of the DMB service provider computer, detects a storing (video and audio recordings) start key value included in the contents such as sound sources, images, etc., and recognizes as a storing (video and audio recordings) object content and stores the contents at a temporary storing region;
(3) a step which a reservation storing key value is detected from the contents such as sound sources, images, etc, and the detected key value is compared with a reservation storing key value previously stored by a user, and when the values are matched, a storing (video and audio recordings) finish key value is detected from the contents such as sound sources, images, etc. of the current broadcasting, the receiving terminal generates a charge data for paying a copyright royalty of the contents such as sound sources, images, etc. transmitted in accordance with a control of the DMB service provider computer;
(4) a step which the generated charge data is transmitted to the charge process service provider computer through a communication network (return channel: a cellular phone communication network which performs a wireless internet and a short message service, a bi-directional pager network, a mobile internet (WiBro), etc);
(5) a step which when a receiving acknowledgment data of informing the receipt of the charge data is received from the charge process service provider computer, the receiving terminal finishes the charge data transmission, and stores the contents such as sound sources, images, etc, which are stored at the temporary storing region, at a protection memory of the receiving terminal, and a storing success message is displayed on the screen;
(6) a step which the charge process service provider computer, which received the charge data for charging a copyright royalty from the receiving terminal, calculates a copyright royalty paid by each user based on the charge data received from the receiving terminal and transmits the calculated copyright royalty calculation information to the DMB service provider computer through a communication network; and
(7) a step which the DMB service provider computer controls a copyright royalty charging process of each user based on the copyright royalty calculation information received from the charge process service provider computer and provides part of the profit to the charge process service provider computer for the submission of the copyright royalty calculation information.

16. The method of claim 15, wherein said step (3) further includes a step which a reservation storing key value is detected from the contents such as sound sources, images, etc, and the contents such as sound sources, images, etc. stored at the temporary storing region are deleted when there is not a reservation storing key value previously stored by the user, or when the detected reservation storing key value is not matched with the previously stored reservation storing key value, or when a storing (video and audio recordings) finish key value is detected from the contents such as sound sources, images, etc. of the current broadcasting.
